(19) United States
(12) Patent Application Publication
(10) Pub. No.: US 2012/0146977 A1
(43) Pub. Date: Jun. 14, 2012

(54) WORKING VOLTAGE SWITCHING SYSTEM FOR LIQUID CRYSTAL PANEL AND SWITCHING METHOD THEREOF

(76) Inventors: Ming Han TSAI, Taoyuan County (TW); Yuan Hsin TSOU, Taoyuan County (TW); Kuang Lang Chen, Taoyuan (TW)

(21) Appl. No.: 13/150,881

(22) Filed: Jun. 1, 2011

(30) Foreign Application Priority Data
Dec. 9, 2010 (TW) 099143020

(51) Int. Cl. G09G 5/00

(52) U.S. Cl. 345/211

(57) ABSTRACT

A working voltage switching system for a liquid crystal panel and a switching method thereof are presented. A timing controller of the panel acquires a liquid crystal enable signal to generate a clock signal, and a clock generator acquires the clock signal to control a liquid crystal control element of the liquid crystal panel, and acquires a basic signal supplied by a voltage supplier and a first signal provided by the voltage supplier and transferred by a switch, so as to adjust a signal difference of the clock signal. When a counter judges that the liquid crystal panel is enabled and a count condition is reached, a switch acts to transfer a second signal provided by the voltage supplier, and the clock signal is adjusted to satisfy a signal difference between the basic signal and the second signal.

### CROSS-REFERENCE TO RELATED APPLICATION

This application claims the benefit of Taiwan Patent Application No. 099143020, filed on Dec. 9, 2010, which is hereby incorporated by reference for all purposes as if fully set forth herein.

### BACKGROUND OF THE INVENTION

1. Field of Invention

The present invention relates to a working power system for a liquid crystal panel, and more particularly to a working voltage switching system for a liquid crystal panel capable of switching a working voltage and a switching method thereof.

2. Related Art

In the prior art, when the liquid crystal panel works in a low temperature environment, the liquid crystal elements are usually unable to enter a working state rapidly when being enabled as the temperature of the elements is too low due to the extremely cold environment. Especially for the existing Gate in panel (GIP), a panel having a GIP architecture has a insufficient signal power output capability in the low temperature environment, the liquid crystal elements are unable to work normally right away, so within a few seconds after the switch-on, delays, abnormalities, or stops might occur to the pictures. When the manufacturers fabricate the liquid crystal panel, the sales regions of the panels are considered. If the sales region is a cold region, the manufacturers have special designs for the liquid crystal panel.

The special designs at least include two cases as follows. In one case, a channel width/channel length ratio of the liquid crystal element is increased, so the current power of the channel is increased, thereby forcing the liquid crystal element to work. In another case, a voltage value for controlling a clock control signal of the liquid crystal element is increased, so as to force the liquid crystal element to be driven to work with a relatively high voltage.

However, the power consumption of the liquid crystal panel is increased in both the special designs, but the contrast between the working efficiency the elementservice life and the practical energy loss of the liquid crystal panel does not satisfy the economic efficiency, and at the same time the unnecessary power loss cost is increased.

Therefore, the manufacturers consider the problem of how to enable the liquid crystal panel to be normally switched on and work in the low temperature environment while avoiding excessive power consumption.

### SUMMARY OF THE INVENTION

The present invention is directed to a liquid crystal panel that does not have picture abnormality during switch-on and high power consumption in a low temperature environment.

In order to solve the problem of the liquid crystal panel, the present invention provides a working voltage switching system for a liquid crystal panel, which comprises a voltage supplier, a switch, a counter, a timing controller, and a clock generator.

The voltage supplier is used for providing a basic signal, a first signal, and a second signal. The switch is connected to the voltage supplier to acquire the first signal and the second signal, so as to select to output one of the first signal and the second signal. The counter is connected to the switch, and when the counter counts and judges that a count condition is satisfied, the counter controls the switch to switch from the first signal to the second signal. The timing controller receives an external liquid crystal enable signal, so as to generate a liquid crystal control signal. The clock generator is connected to the timing controller to acquire the liquid crystal control signal, and generates a clock signal used for controlling a liquid crystal control element of the liquid crystal panel according to the liquid crystal control signal. The clock generator is connected to the voltage supplier and the switch, adjusts a signal difference of the clock signal according to a signal difference between the basic signal and the first signal when acquiring the basic signal and the first signal, and adjusts the signal difference of the clock signal according to a signal difference between the basic signal and the second signal when acquiring the basic signal and the second signal.

In order to solve the problem of the liquid crystal panel, the present invention provides a working voltage switching method for a liquid crystal panel, which comprises the following steps. A timing controller acquires a liquid crystal enable signal to generate a liquid crystal control signal, and a clock generator generates a clock signal according to the liquid crystal control signal. The clock generator acquires a basic signal and a first signal provided by a switch, so as to adjust a signal difference of clock signal to be a signal difference between the basic signal and the first signal. The clock signal is used for controlling a liquid crystal control element of the liquid crystal panel. When a counter acts and judges whether a count condition is satisfied, the counter drives the switch to provide a second signal to replace the first signal. The clock generator adjusts the signal difference of the clock signal to be a signal difference between the basic signal and the second signal.

A characteristic of the present invention is that the present invention enables normal work of a liquid crystal panel without being limited by a panel temperature, especially for a liquid crystal panel having a GIP architecture, even in a low temperature environment, a large power electricity drives a liquid crystal element when the panel is switched on, so as to avoid a condition that pictures are abnormal within a few seconds after the panel is switched on resulting from that the liquid crystal element is unable to work normally right away due to insufficient signal power output. Next, for the liquid crystal panel, after a few seconds, a working temperature rises, the required power and power consumption of the liquid crystal control element and the liquid crystal element controlled thereby are not as large as those when being enabled, so the normal working power is recovered in a few seconds after switch-on, so as to effectively reduce the consumed power of the liquid crystal panel, thereby maintaining a working efficiency of the liquid crystal panel while prolonging an element service life and reducing a practical energy loss, and avoiding unnecessary power loss cost.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a first architecture of a working voltage switching system for a liquid crystal panel according to an embodiment of the present invention;

FIG. 2 is a schematic view of a signal difference change of a clock signal according to an embodiment of the present invention;

FIG. 3 is a schematic view of a second architecture of a working voltage switching system for a liquid crystal panel according to an embodiment of the present invention;

FIG. 4 is a schematic view of a third architecture of a working voltage switching system for a liquid crystal panel according to an embodiment of the present invention;

FIG. 5 is a schematic view of a fourth architecture of a working voltage switching system for a liquid crystal panel according to an embodiment of the present invention;

FIG. 6 is a schematic view of a fifth architecture of a working voltage switching system for a liquid crystal panel according to an embodiment of the present invention;

FIG. 7 is a schematic view of another signal difference change of a clock signal according to an embodiment of the present invention;

FIG. 8 is a schematic flow chart of a working voltage switching method for a liquid crystal panel;

FIG. 9 is a subsequent schematic flow chart of a working voltage switching method for a liquid crystal panel according to an embodiment of the present invention; and

FIG. 10 is a subsequent schematic flow chart of a working voltage switching method for a liquid crystal panel according to an embodiment of the present invention.

### DETAILED DESCRIPTION OF THE INVENTION

The preferred embodiments of the present invention are illustrated below in detail with reference to the accompanying drawings.

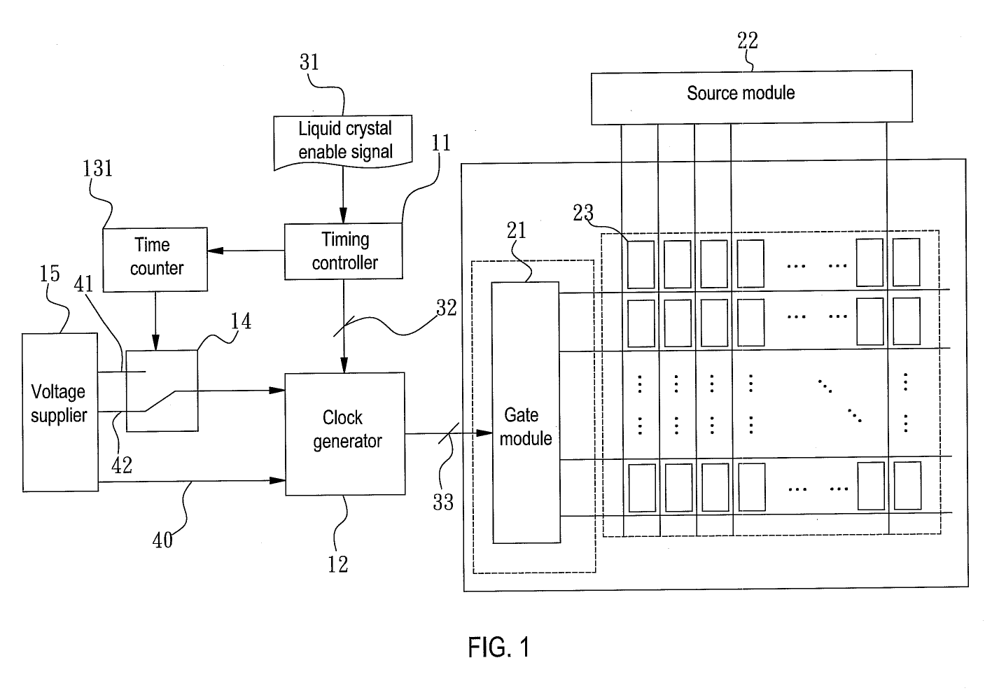

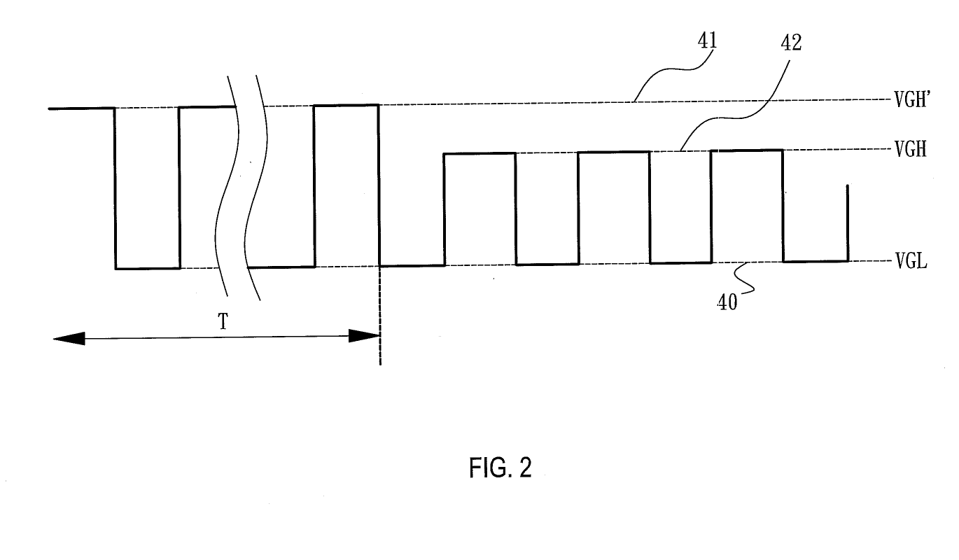

First, referring to FIG. 1 and FIG. 2, FIG. 1 is a schematic view of a first architecture of a working voltage switching system for a liquid crystal panel according to an embodiment of the present invention, and FIG. 2 is a schematic view of a signal difference change of a clock signal according to an embodiment of the present invention.

The system is built inside a liquid crystal panel having a GIP architecture. The liquid crystal panel includes a plurality of liquid crystal elements 23 and liquid crystal control elements thereof. The liquid crystal elements 23 are connected by a plurality of scanning signal lines in rows and a plurality of data signal lines in columns. The data signal line and the scanning signal line are individually connected by more than one liquid crystal control elements, for example, each data signal line is connected to at least one source module 22, each scanning signal line is connected to at least one gate module 21 built in the panel. In this embodiment, interactive operations of the system and the gate module 21 are illustrated.

The system includes a voltage supplier 15, a switch 14, a time counter 131, a timing controller 11, and a clock generator 12.

In this embodiment, the voltage supplier 15 is used for providing a first signal(VGH′) 41, a second signal(VGH)42, and a basic signal(VGL) 40. It is assumed here that the first signal 41 is a gate control voltage (VGH′) having a relatively high voltage value, and the second signal 42 is another gate control voltage (VGH) having a voltage lower than that of the first signal. A signal difference between the second signal (VGH) 42 and the basic signal (VGL) 40 is a normal working voltage value of a gate module 21. A switch 14 is connected to the voltage supplier 15, and acquires the first signal (VGH′) 41 and the second signal (VGH) 42. The counter is, for example, a time counter 131, which is connected to the switch 14 and performs a count operation when being enabled. The timing controller 11 is connected to the time counter 131 and the clock generator 12. The clock generator 12 is then connected to the timing controller 11, the switch 14, the voltage supplier 15, and the gate module 21 built in the panel.

When acquiring an externally input liquid crystal enable signal 31, the timing controller 11 generates a liquid crystal control signal 32 including time information of liquid crystal driving according to the liquid crystal enable signal 31. The clock generator 12 acquires the liquid crystal control signal 32, so as to generate a clock signal 33 for controlling the gate module 21.

Furthermore, the timing controller 11 enables the time counter 131. The time counter 131 performs a time count operation. At this time, the switch 14 provides a first signal (VGH′) 41 to the clock generator 12, or the time counter 131 drives the switch 14 to perform a switching operation, so as to provide the first signal (VGH′) 41 to the clock generator 12. In a count period T, the clock generator 12 acquires the first signal (VGH′) 41 and a basic signal (VGL) 40 provided by the voltage supplier 15, and adjusts a signal difference of the clock signal 33 to satisfy a signal difference between the first signal (VGH′) 41 and the basic signal (VGL) 40.

As shown in FIG. 2, for the clock signal 33, in the count period T, a signal peak value thereof is the first signal (VGH′) 41, a signal trough value thereof is the basic signal (VGL) 40, so a difference value between the peak and the trough of the clock signal 33 is the signal difference between the first signal (VGH′) 41 and the basic signal (VGL) 40.

When the counters judges that the performed time count satisfies a count condition, in this example, that is, the time counter 131 judges that a calculated time length reaches a time threshold value, the time counter 131 drives the switch 14 to perform a switching procedure, so as to switch the output signal from the first signal (VGH′) 41 to the second signal (VGH) 42. At this time, the clock generator 12 acquires the second signal (VGH) 42 and the basic signal (VGL) 40 provided by the voltage supplier 15, and adjusts a signal difference of the clock signal 33 to satisfy a signal difference between the second signal (VGH) 42 and the basic signal (VGL) 40.

As shown in FIG. 2, the signal peak value of the clock signal 33 decreases from the first signal (VGH′) 41 to the second signal (VGH) 42, and the signal trough value is still the basic signal (VGL) 40, so the difference value between the peak and the trough of the clock signal 33 changes into the signal difference between the second signal (VGH) 42 and the basic signal (VGL) 40. As discussed above, the signal difference between the second signal (VGH) 42 and the basic signal (VGL) 40 is the normal working voltage value of the gate module 21, so the clock generator 12 continuously provides the clock signal 33 having the normal working voltage to the gate module 21.

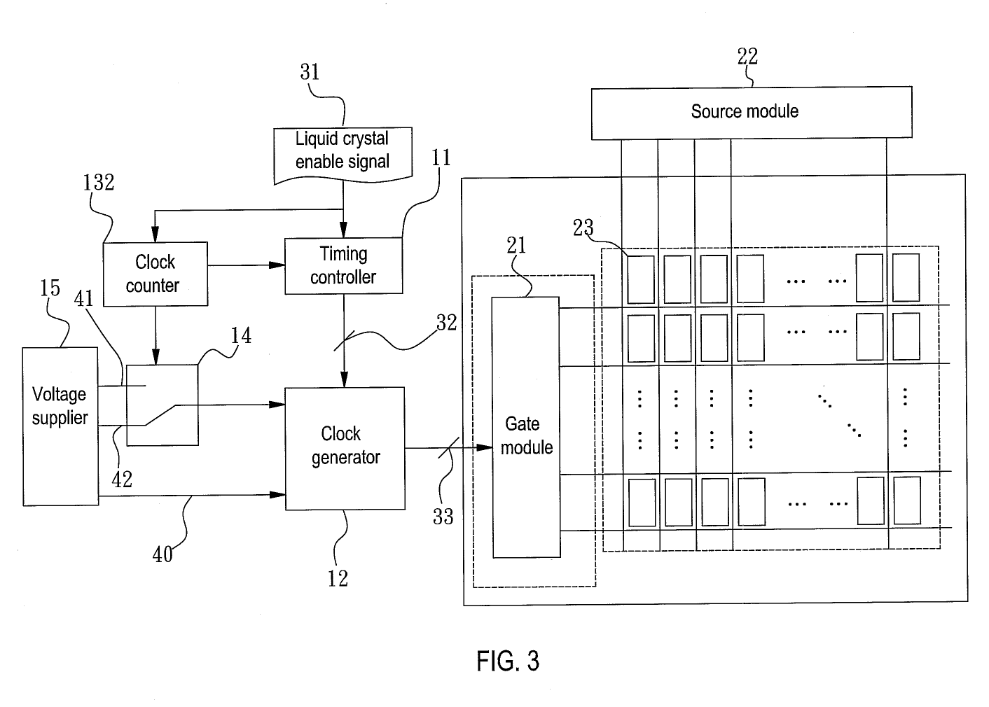

FIG. 3 is a schematic view of a second architecture of a working voltage switching system for a liquid crystal panel according to an embodiment of the present invention, and FIG. 2 is a schematic view of a signal difference change of a clock signal according to an embodiment of the present invention. Referring to FIG. 3 and FIG. 2, a difference between this embodiment and the embodiment in FIG. 1 is as follows. The counter is a clock counter 132, the clock counter 132 is used for calculating a clock number of the liquid crystal enable signal 31, and a count condition is that the clock number of the liquid crystal enable signal 31 reaches a clock threshold value. When judging that the clock number of the liquid crystal enable signal 31 reaches the clock threshold value, the clock counter 132 drives the switch 14 to perform a switching procedure, so as to switch the output signal from the first signal (VGH′) 41 to the second signal (VGH) 42. At this time, the clock generator 12 acquires the second signal (VGH) 42 and the basic signal (VGL) 40 provided by the voltage supplier 15, and adjusts the signal difference of the clock signal 33 to satisfy the signal difference between the second signal (VGH) 42 and the basic signal (VGL) 40.

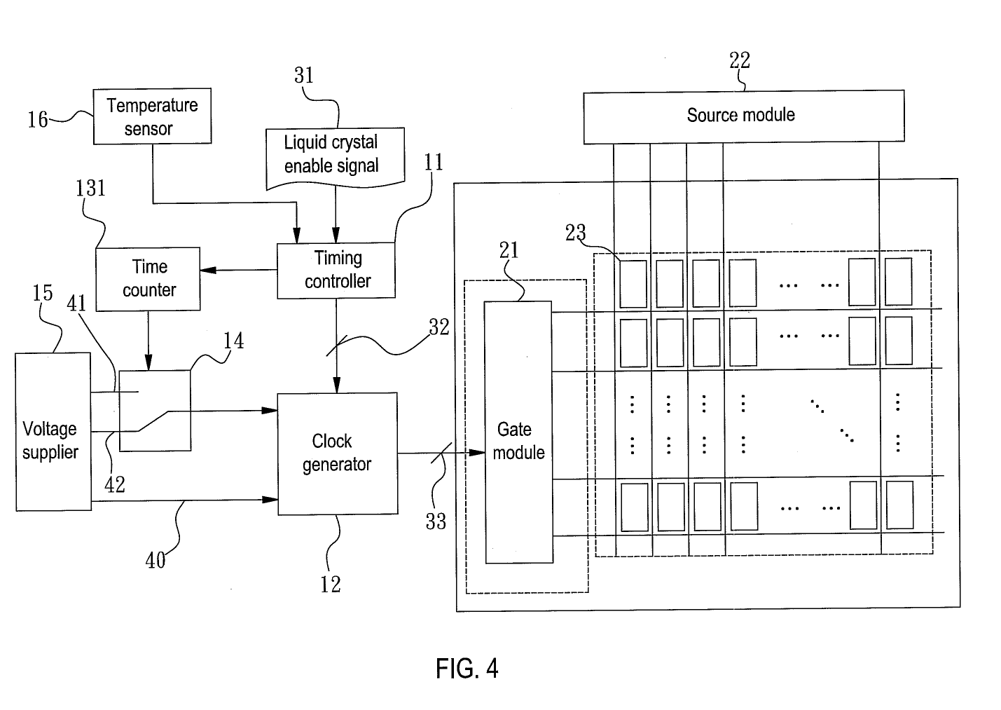

FIG. 4 is a schematic view of a third architecture of a working voltage switching system for a liquid crystal panel according to an embodiment of the present invention. Referring to FIG. 4, a difference between this embodiment and the above embodiment is that the system according to this embodiment further includes a temperature sensor 16, and the temperature sensor 16 is also configured on the liquid crystal panel and connected to the timing controller 11. When the temperature sensor 16 judges that a panel temperature of the liquid crystal panel reaches a temperature lower limit value, the timing controller 11 enables the counter (the time counter 131 or the clock counter 132 as discussed above), so the counter drives the switch 14 to perform a switching action, so as to provide the first signal (VGH′) 41 to the clock generator 12 again.

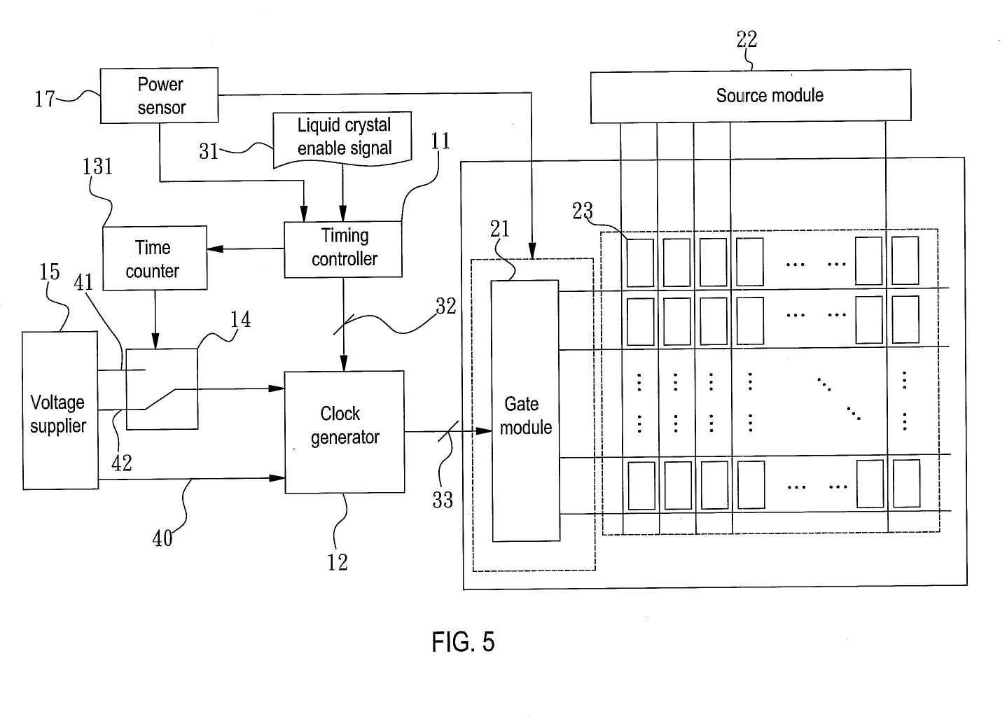

FIG. 5 is a schematic view of a fourth architecture of a working voltage switching system for a liquid crystal panel according to an embodiment of the present invention. Referring to FIG. 5, a difference between this embodiment and the above embodiment is that the system according to this embodiment further includes a power sensor 17, and the power sensor 17 is also configured on the liquid crystal panel and connected to the above liquid crystal control element, for example, the gate module 21. When the power sensor 17 judges that a current power of the gate module 21 does not satisfy a working power (no matter whether the liquid crystal drive voltage is insufficient or the liquid crystal drive current is too low), the timing controller 11 enables the counter (the time counter 131 or the clock counter 132 as discussed above), so the counter drives the switch 14 to perform a switching action, so as to provide the first signal (VGH′) 41 to the clock generator 12 again.

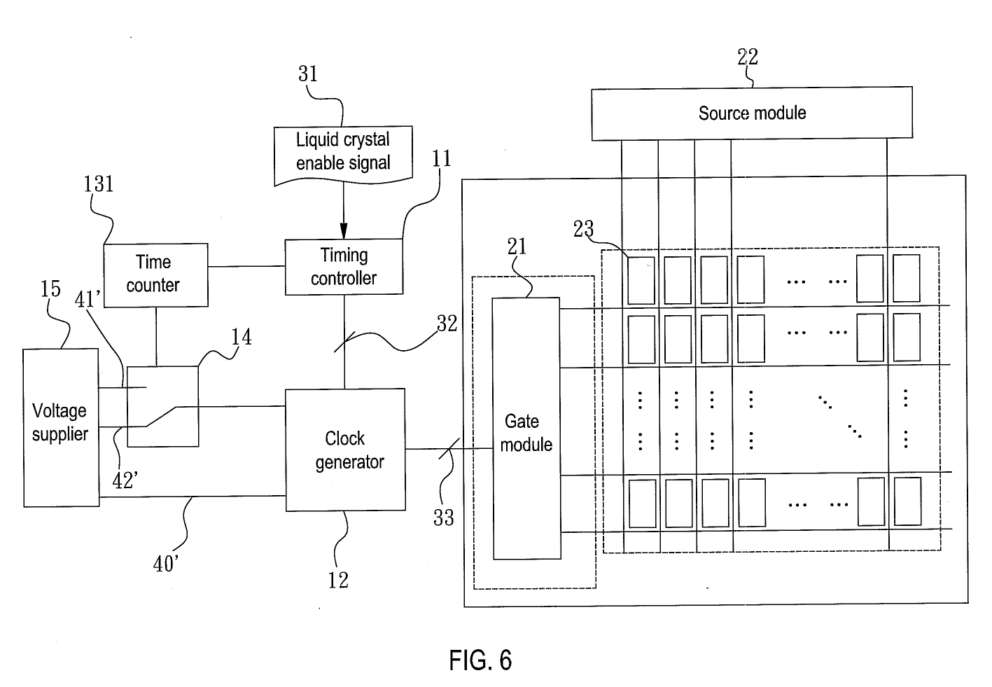

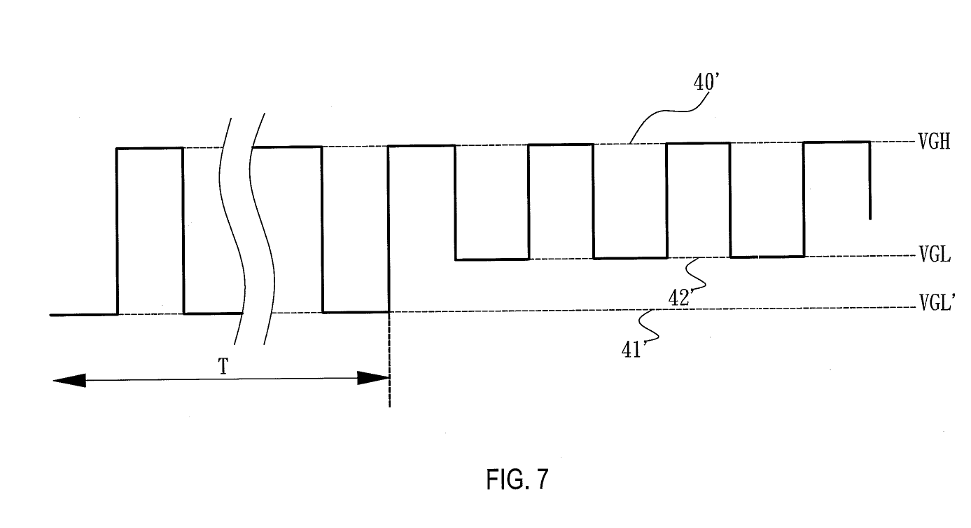

Referring to FIG. 6 and FIG. 7, FIG. 6 is a schematic view of a fifth architecture of a working voltage switching system for a liquid crystal panel according to an embodiment of the present invention, and FIG. 7 is a schematic view of another signal difference change of a clock signal according to an embodiment of the present invention.

A difference between this embodiment and the above embodiment in FIG. 1 is as follows. The first signal 41′ is a gate control voltage (VGL′) having a relatively low voltage value, the second signal 42′ is another gate control voltage (VGL) having a voltage higher than that of the first signal, and the signal difference between the second signal (VGL) 42′ and the basic signal (VGH) 40′ is a normal working voltage value of the gate module 21.

When the time counter 131 performs a time count operation, the switch 14 provides a first signal (VGL′) 41′ to the clock generator 12, or the time counter 131 drives the switch 14 to perform a switching operation, so as to provide the first signal (VGL′) 41′ to the clock generator 12. In the count period T, the clock generator 12 acquires the first signal (VGL′) 41′ and the basic signal (VGH) 40′ provided by the voltage supplier 15, and adjusts the signal difference of the clock signal 33 to satisfy the signal difference between the first signal (VGL′) 41′ and the basic signal (VGH) 40′.

As shown in FIG. 7, for the clock signal 33, in the count period T, the signal trough value thereof is the first signal (VGL′) 41′, and the signal peak value thereof is the basic signal (VGH) 40′, so the difference value between the peak and the trough of the clock signal 33 is the signal difference between the first signal (VGL′) 41′ and the basic signal (VGH) 40′.

When the counter judges that the performed time count satisfies a count condition, in this example, the time counter 131 judges that a calculated time length reaches a time threshold value, the time counter 131 drives the switch 14 to perform a switching procedure, so as to switch the output signal from the first signal (VGL′) 41′ to the second signal (VGL) 42′. At this time, the clock generator 12 acquires the second signal (VGL) 42′ and the basic signal (VGH) 40′ provided by the voltage supplier 15, and adjusts the signal difference of the clock signal 33 to satisfy the signal difference between the second signal (VGL) 42′ and the basic signal (VGH) 40′.

As shown in FIG. 7, the signal trough value of the clock signal 33 rises from the first signal (VGL′) 41′ to the second signal (VGL) 42′, and the signal peak value is still the basic signal (VGH) 40′, so the difference value between the peak and the trough of the clock signal 33 becomes the signal difference between the second signal (VGL) 42′ and the basic signal (VGH) 40′. As discussed above, the signal difference between the second signal (VGL) 42′ and the basic signal (VGH) 40′ is the normal working voltage value of the gate module 21, so the clock generator 12 continuously provides the clock signal 33 having the normal working voltage to the gate module 21.

However, the temperature sensor 16, the power sensor 17, and two counters as shown in FIG. 3, FIG. 4, and FIG. 5 can be integrated in the system in FIG. 1 or FIG. 6 separately or as a combination of more than two elements, and the present invention is not limited to the embodiments.

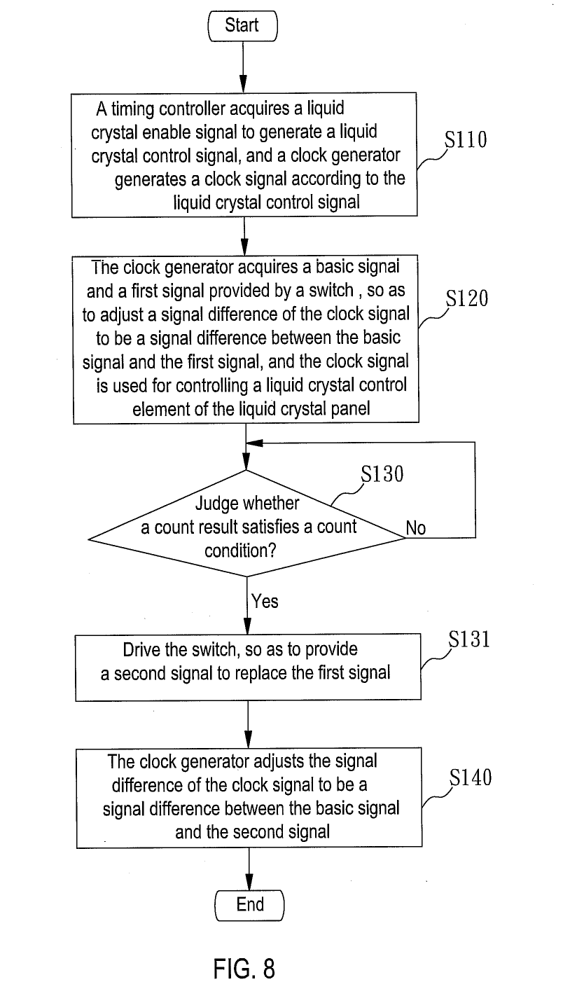

FIG. 8 is a schematic flow chart of a working voltage switching method for a liquid crystal panel. Referring to FIG. 8 and FIG. 1 to FIG. 7 at the same time for ease of understanding, the working voltage switching method for a liquid crystal panel is illustrated in detail as follows.

A timing controller 11 acquires a liquid crystal enable signal 31 to generate a liquid crystal control signal 32, and a clock generator 12 generates a clock signal 33 according to the liquid crystal control signal 32 (Step S110).

As for FIG. 1 and FIG. 6, when acquiring an externally input liquid crystal enable signal 31, the timing controller 11 generates a liquid crystal control signal 32 including time information of liquid crystal driving according to the liquid crystal enable signal 31. The clock generator 12 acquires the liquid crystal control signal 32, so as to generate a clock signal 33 for controlling a gate module 21.

The clock generator 12 acquires a basic signal and a first signal provided by a switch 14, so as to adjust a signal difference of the clock signal 33 to be a signal difference between the basic signal and the first signal, and the clock signal 33 is used for controlling a liquid crystal control element of the liquid crystal panel (Step S120).

For FIG. 1 and FIG. 2, the timing controller 11 enables the time counter 131. The time counter 131 performs a time count operation. At this time, the switch 14 provides a first signal (VGH′) 41 to the clock generator 12, or the time counter 131 drives the switch 14 to perform a switching operation, so as to provide the first signal (VGH′) 41 to the clock generator 12. In a count period T, the clock generator 12 acquires the first signal (VGH′) 41 and the basic signal (VGL) 40 provided by the voltage supplier 15, and adjusts the signal difference of the clock signal 33 to satisfy a signal difference between the first signal (VGH′) 41 and the basic signal (VGL) 40.

For FIG. 6 and FIG. 7, the switch 14 provides the first signal (VGL′) 41′ to the clock generator 12, or the time counter 131 drives the switch 14 to perform a switching operation, so as to provide the first signal (VGL′) 41′ to the clock generator 12. In the count period T, the clock generator 12 acquires the first signal (VGL′) 41′ and the basic signal (VGH) 40′ provided by the voltage supplier 15, and adjusts the signal difference of the clock signal 33 to satisfy the signal difference between the first signal (VGL′) 41′ and the basic signal (VGH) 40′.

In FIG. 3, the timing controller 11 enables the clock counter 132, the clock counter 132 calculates a clock number of the liquid crystal enable signal 31. At this time, the switch 14 provides the first signal (VGH′) 41 to the clock generator 12, or the clock counter 132 drives the switch 14 to perform a switching operation, so as to provide the first signal (VGH′) 41 to the clock generator 12. In the clock count period T, the clock generator 12 acquires the first signal (VGH′) 41 and the basic signal (VGL) 40 provided by the voltage supplier 15, and adjusts the signal difference of the clock signal 33 to satisfy the signal difference between the first signal (VGH′) 41 and the basic signal (VGL) 40.

The counter judges whether a count result satisfies a count condition (Step S130). For the time counter 131, the count condition is that the time counter 131 judges that a calculated time length reaches a time threshold value. For the clock counter 132, the count condition is that the clock number of the liquid crystal enable signal 31 reaches a clock threshold value.

When the counter judges that the count result does not satisfy a count condition, the process returns to Step S130 to continuously determine whether the count condition is satisfied.

When judging that the count result already satisfies a count condition, the counter drives the switch 14, so as to provide a second signal to replace the first signal (Step S131).

For the embodiments in FIG. 1 and FIG. 2, when the time counter 131 judges that the calculated time length reaches the time threshold value, the time counter 131 drives the switch 14 to perform a switching procedure, so as to switch the output signal from the first signal (VGH′) 41 to the second signal (VGH) 42. At this time, the clock generator 12 acquires the second signal (VGH) 42 and the basic signal (VGL) 40 provided by the voltage supplier 15.

For the embodiment in FIG. 3, when judging that the clock number of the liquid crystal enable signal 31 reaches a clock threshold value, the clock counter 132 drives the switch 14 to perform a switching procedure, so as to switch the output signal from the first signal (VGH′) 41 to the second signal (VGH) 42. At this time, the clock generator 12 acquires the second signal (VGH) 42 and the basic signal (VGL) 40 provided by the voltage supplier 15.

For the embodiments in FIG. 6 and FIG. 7, when judging that the calculated time length reaches the time threshold value, the time counter 131 drives the switch 14 to perform a switching procedure, so as to switch the output signal from the first signal (VGL′) 41′ to the second signal (VGL) 42′. At this time, the clock generator 12 acquires the second signal (VGL) 42′ and the basic signal (VGH) 40′ provided by the voltage supplier 15.

Subsequently, the clock generator adjusts the signal difference of the clock signal 33 to be a signal difference between the basic signal and the second signal (Step S140).

For the embodiments in FIG. 1, FIG. 2, and FIG. 3, the clock generator 12 adjusts the signal difference of the clock signal 33 according to the second signal (VGH) 42 and the basic signal (VGL) 40, so as to satisfy the signal difference between the second signal (VGH) 42 and the basic signal (VGL) 40.

As shown in FIG. 2, the signal peak value of the clock signal 33 decreases from the first signal (VGH′) 41 to the second signal (VGH) 42, and the signal trough value is still the basic signal (VGL) 40, so the difference value between the peak and the trough of the clock signal 33 becomes the signal difference between the second signal (VGH) 42 and the basic signal (VGL) 40. As discussed above, the signal difference between the second signal (VGH) 42 and the basic signal (VGL) 40 is the normal working voltage value of the gate module 21, so the clock generator 12 continuously provides the clock signal 33 having the normal working voltage to the gate module 21.

For the embodiments in FIG. 6 and FIG. 7, the clock generator 12 adjusts the signal difference of the clock signal 33 according to the second signal (VGL) 42′ and the basic signal (VGH) 40′, so as to satisfy the signal difference between the second signal (VGL) 42′ and the basic signal (VGH) 40′.

As shown in FIG. 7, the signal trough value of the clock signal 33 rises from the first signal (VGL′) 41′ to the second signal (VGL) 42′, and the signal peak value is still the basic signal (VGH) 40′, so the difference value between the peak and the trough of the clock signal 33 becomes the signal difference between the second signal (VGL) 42′ and the basic signal (VGH) 40′. As discussed above, the signal difference between the second signal (VGL) 42′ and the basic signal (VGH) 40′ is the normal working voltage value of the gate module 21, so the clock generator 12 continuously provides the clock signal 33 having the normal working voltage to the gate module 21.

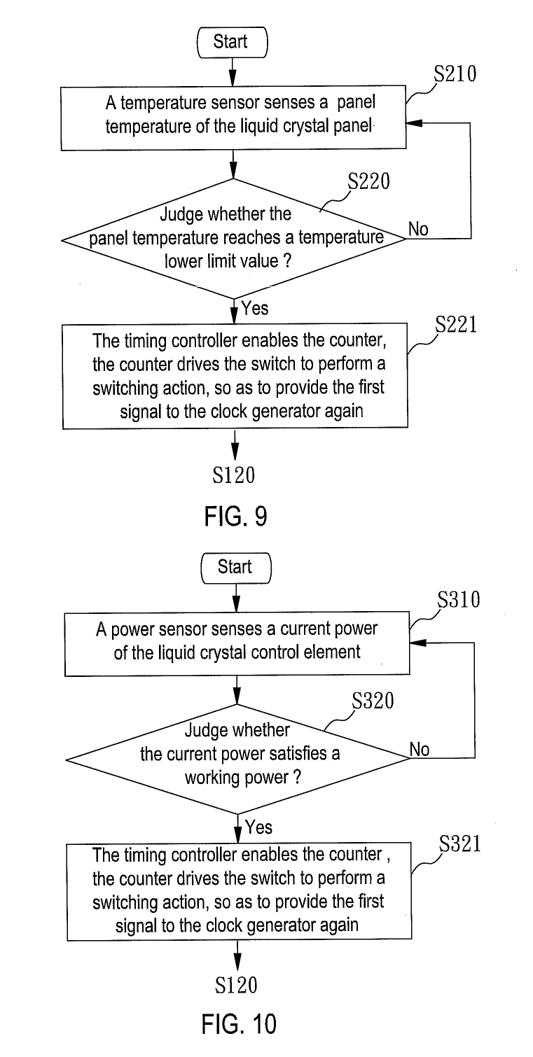

FIG. 9 is a subsequent schematic flow chart of a working voltage switching method for a liquid crystal panel according to an embodiment of the present invention. Referring to FIG. 9, FIG. 2 and FIG. 4 at the same time for ease of understanding, the method is illustrated as follows.

A temperature sensor 16 senses a panel temperature of the liquid crystal panel (Step S210). The temperature sensor 16 is also configured on the liquid crystal panel and connected to the timing controller 11.

The temperature sensor 16 judges whether the panel temperature reaches a temperature lower limit value (Step S220). When the temperature sensor 16 judges that the panel temperature reaches a temperature lower limit value, the timing controller 11 enables the counter (the time counter 131 or the clock counter 132 as discussed above), so the counter drives the switch 14 to perform a switching action, so as to provide the first signal (VGH′) 41 to the clock generator 12 again (Step S221). Subsequently, Step S120 is performed, so the process returns to the working voltage switching procedure of the clock signal 33 in Step S120 to Step S140 as shown in FIG. 8.

On the contrary, when the temperature sensor 16 judges that the panel temperature does not reach a temperature lower limit value, the process returns to Step S210 to continuously sense the panel temperature of the liquid crystal panel.

FIG. 10 is a subsequent schematic flow chart of a working voltage switching method for a liquid crystal panel according to an embodiment of the present invention. Referring to FIG. 10, FIG. 2 and FIG. 5 at the same time for ease of understanding, the method is illustrated as follows.

A power sensor 17 senses a current power of the liquid crystal control element (Step S310). The power sensor 17 is also configured on the liquid crystal panel and connected to the above liquid crystal control element, for example, the gate module 21.

The power sensor 17 judges whether the current power satisfies a working power (Step S320). When the power sensor 17 judges that the current power does not satisfy a working power (no matter whether the liquid crystal drive voltage is insufficient or the liquid crystal drive current is too low), the timing controller 11 enables the counter (the time counter 131 or the clock counter 132 as discussed above), the counter drives the switch 14 to perform a switching action, so as to provide the first signal (VGH′) 41 to the clock generator 12 again (Step S321). Subsequently, Step S120 is performed, so the process returns to the working voltage switching procedure of the clock signal 33 in Step S120 to Step S140 as shown in FIG. 8.

On the contrary, when the power sensor 17 judges that the current power satisfies a working power, the process returns to Step S310 to continuously sense the current power of the liquid crystal control element.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A working voltage switching system for a liquid crystal panel, comprising:
a voltage supplier, used for providing a basic signal, a first signal, and a second signal;
a switch, connected to the voltage supplier to acquire the first signal and the second signal, so as to select to output one of the first signal the second signal;
a counter, connected to the switch, and used for counting and controlling the switch to switch from the first signal to the second signal when judging that a count result satisfies a count condition;
a timing controller, used for receiving an external liquid crystal enable signal, so as to generate a liquid crystal control signal; and
a clock generator, connected to the timing controller to acquire the liquid crystal control signal, used for generating a clock signal used for controlling a liquid crystal control element of the liquid crystal panel according to the liquid crystal control signal, connected to the voltage supplier and the switch, used for adjusting a signal difference of the clock signal according to a signal difference between the basic signal and the first signal, when acquiring the basic signal and the first signal, and adjusting the signal difference of the clock signal according to a signal difference between the basic signal and the second signal, when acquiring the basic signal and the second signal.

2. The working voltage switching system for a liquid crystal panel according to claim 1, wherein the counter is a time counter, and the count condition is that the time counter calculates a time length reaching a time threshold value.

3. The working voltage switching system for a liquid crystal panel according to claim 1, wherein the counter is a clock counter used for calculating a clock number of the liquid crystal enable signal, and the count condition is that the clock number of the liquid crystal enable signal reaches a clock threshold value.

4. The working voltage switching system for a liquid crystal panel according to claim 1, wherein the signal difference between the first signal and basic signal is greater than a signal difference between the second signal and the basic signal.

5. The working voltage switching system for a liquid crystal panel according to claim 4, wherein a voltage value of the first signal is higher than a voltage value of the second signal, and a voltage value of the basic signal is lower than the voltage value of the second signal.

6. The working voltage switching system for a liquid crystal panel according to claim 4, wherein a voltage value of the second signal is higher than a voltage value of the first signal, and a voltage value of the basic signal is higher than the voltage value of the second signal.

7. The working voltage switching system for a liquid crystal panel according to claim 1, further comprising a temperature sensor connected to the timing controller, wherein when the temperature sensor judges that a panel temperature of the liquid crystal panel reaches a temperature lower limit value, the timing controller enables the counter, and the counter enables the switch to act to provide the first signal.

8. The working voltage switching system for a liquid crystal panel according to claim 1, further comprising a power sensor, wherein when the power sensor senses that a current power of the liquid crystal control element does not satisfy a working power, the timing controller enables the counter, and the counter enables the switch to act to provide the first signal.

9. A working voltage switching method for a liquid crystal panel, comprising:
a timing controller acquiring a liquid crystal enable signal to generate a liquid crystal control signal, and a clock generator generating a clock signal according to the liquid crystal control signal;
the clock generator acquiring a basic signal and a first signal provided by a switch, so as to adjust a signal difference of the clock signal to be a signal difference between the basic signal and the first signal, wherein the clock signal is used for controlling a liquid crystal control element of the liquid crystal panel;
when a counter acts and judges that a count result satisfies a count condition, the counter driving the switch to provide a second signal to replace the first signal; and
the clock generator adjusting the signal difference of the clock signal to be the signal difference between the basic signal and the second signal.

10. The working voltage switching method for a liquid crystal panel according to claim 9, further comprising:
a temperature sensor sensing a panel temperature of the liquid crystal panel; and
when the temperature sensor judges that the panel temperature reaches a temperature lower limit value, the timing controller enabling the counter, and the counter enabling the switch to act to provide the first signal.

11. The working voltage switching method for a liquid crystal panel according to claim 9, further comprising:
a power sensor sensing a current power of the liquid crystal control element; and
when the power sensor judges that the current power does not satisfy a working power, the timing controller enabling the counter, and the counter enabling the switch to act to provide the first signal.

12. The working voltage switching method for a liquid crystal panel according to claim 9, wherein the counter is a time counter, and the count condition is that the time counter calculates a time length reaching a time threshold value.

13. The working voltage switching method for a liquid crystal panel according to claim 9, wherein the counter is a clock counter used for calculating a clock number of the liquid crystal enable signal, and the count condition is that the clock number of the liquid crystal enable signal reaches a clock threshold value.
